(19) United States
(12) Patent Application Publication
(10) Pub. No.: US 2004/0224166 A1
(43) Pub. Date: Nov. 11, 2004

(54) Acoustically tuned vehicle floor covering and method of manufacturing an acoustically tuned flooring system

(75) Inventors: Kenneth R. Parrish, Roseville, MI (US); Edward C. Simon, Garden City, MI (US)

Correspondence Address: Stallman & Pollock LLP, Attn: Michael A Stallman, 121 Spear Street, Suite 290, San Francisco, CA, 94105, US

(73) Assignee: Lear Corporation, Southfield, MI

(21) Appl. No.: 10/430,575

(22) Filed: May 6, 2003

(51) Int. Cl. B32B 9/00

(52) U.S. Cl. 428/423.1

(57) ABSTRACT

A method of making a vehicle floor covering by a spray forming process wherein areas of different thickness are provided. The thickness of the non-carpeted floor covering is varied to selectively improve durability, vibration absorption and noise reduction. Thickness may be selectively reduced to minimize material costs and weight reduction requirements. The floor covering is installed on the compartment pan of a vehicle over a decoupler.

### BACKGROUND OF THE INVENTION

1. Field of the Invention

The present invention relates to non-carpeted vehicle floor coverings and a method of making a flooring system using a spray polyurethane process.

2. Background Art

Non-carpeted vehicle floor coverings are used in cars, sport utility vehicles and, in particular, trucks. Non-carpeted vehicle floor coverings offer excellent durability. Such floor coverings may be easily cleaned which makes them preferred for vehicles used at construction sites or industrial locations where dirt and oil may quickly accumulate and ruin carpet-type vehicle floor coverings.

Non-carpeted vehicle floor coverings are currently manufactured in a vacuum forming process wherein a sheet of thermoplastic polymeric material is placed in a vacuum forming mold having a contour corresponding to the shape of the vehicle floor to which it is intended to be attached. During the vacuum forming process, the polymeric sheet is heated and then contoured portions of the floor covering are stretched and thinned where the polymeric sheet is drawn to follow the contour of the vacuum forming die. Vacuum forming also causes distortion of surface texture grain patterns in drawn areas that may lead to quality control problems.

Current vacuum forming processes do not permit control of the thickness of the floor covering so that the floor covering may be made thicker in selected areas and thinner in other areas. For example, in foot wells, it would be preferred to provide increased material thickness to improve durability and resist wear. In contrast, in areas of the floor covering where seats are assembled over the floor covering, it would be desirable to provide the minimum thickness of material to reduce material costs and achieve weight savings.

Non-carpeted floor coverings are normally installed over a decoupler that comprises a fibrous mat, such as shoddy, cast polyurethane foam, polyester batting or the like, secured between the floor covering and compartment pan of the vehicle. The decoupler and floor covering combine to control vibration and absorb noise. The floor covering contributes to vibration and sound control. However, in thinned areas formed during the vacuum forming process vibration and noise control is reduced.

These and other problems and disadvantages associated with prior art non-carpeted floor coverings are addressed by applicants' invention as summarized below.

### SUMMARY OF THE INVENTION

According to one aspect of the present invention, a method of making a vehicle floor covering in a mold is provided by spraying a polymer mixture on to the mold. The mold is an open mold having a forming surface contoured to correspond to at least a portion of a vehicle compartment pan. The polymer mixture sprayed may be a two-part polyurethane mixture or any other suitable polymer that is amenable to spray forming and preferably offering a low gloss, rubber-like texture. The mixture is sprayed on the forming surface of the mold in at least two different thicknesses on to different portions of the forming surface. The thickness of the spray is controlled to improve the characteristics of the floor covering such as the durability, noise transmission, or vibration dampening characteristics.

According to another aspect of the invention, a floor covering is made by a spray urethane forming process for a vehicle having a non-carpeted floor. The floor covering comprises a sprayed polyurethane layer that is molded to a contour corresponding to the shape of at least a portion of the floor of the vehicle. The layer has a first thickness in certain portions and a second thickness that is greater than the first thickness in other predetermined regions of the layer. The second, thicker portions of the layer, may be formed in locations to control noise and vibration to a greater extent than noise and vibration may be controlled by the first or thinner portions of the layer. A vehicle may have acoustical hot spots that are focus points for the transmission of noise and vibration and baseline noise and vibration areas that tend to transmit less noise and vibration. The floor covering is formed with a plurality of different thicknesses that may be varied to provide increased thickness over the acoustical hot spots and lesser thickness in the baseline areas.

According to other aspects of the inventions described above, the mixture sprayed in the spraying step may be a polyurethane. The forming surface of the mold may have a textured surface that is transferred to a top surface of the floor covering. The floor of the vehicle is understood to have seat receiving portions or regions that are covered by vehicle seats when the seats are assembled to the vehicle floor.

### BRIEF DESCRIPTION OF THE DRAWINGS

FIG. 1 is a diagrammatic partially cross-sectional view of a mold and two spray guns applying a polymer composition to a forming surface of the mold;

FIG. 2 is a perspective view of a floor covering for a vehicle having a compartment pan over which a decoupler and floor covering is placed;

FIG. 3 is a magnified view of the portion of the vehicle floor shown in FIG. 2 within the circle 3; and

FIG. 4 is a cross-sectional view taken along the line 4-4 in FIG. 2.

### DETAILED DESCRIPTION OF THE PREFERRED EMBODIMENT(S)

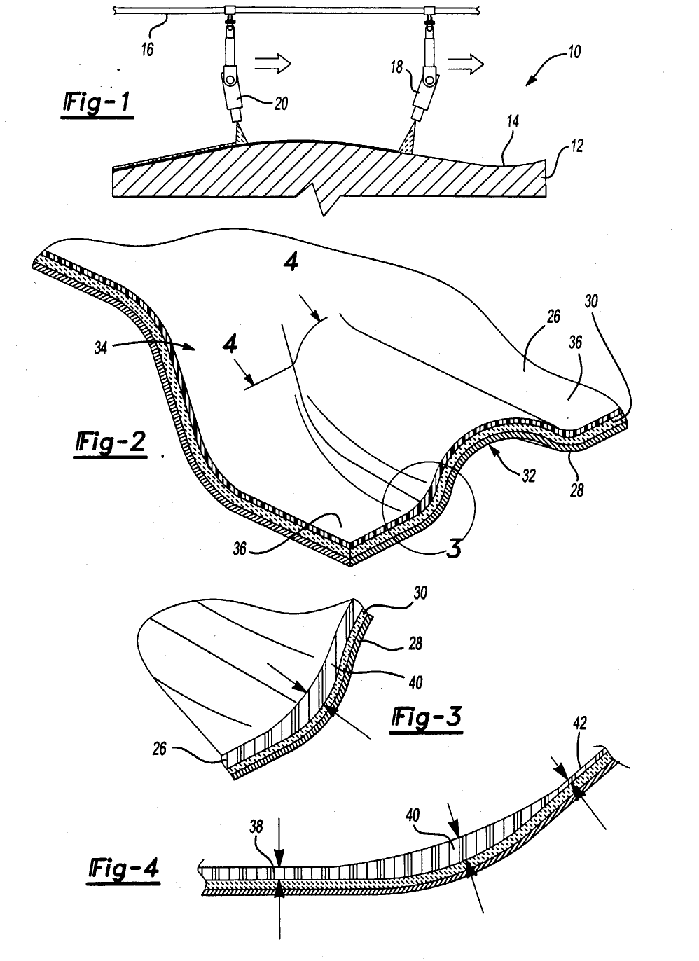

Referring to FIG. 1, a spray forming system 10 is schematically illustrated that may be used to form a non-carpeted flooring system in accordance with the present invention. The spray forming system 10 includes a mold 12 defining a forming surface 14. The forming surface 14 is textured in accordance with a design specification as to the desired texture to be formed. The forming surface 14 is also preferably contoured to a desired shape as will be more fully described below. The spray forming system also includes a spray machine 16 that provides a polymer mixture to first and second spray guns 18 and 20. The polymer mixture may be a polyurethane material. One example of a suitable polyurethane is an aromatic polyurethane that is available from BASF Corporation. An aliphatic polyurethane can also be used. The first and/or second gun 18, 20 may be used to apply polyurethane. The mold is coated initially with a mold release compound as is conventional in the art.

Referring to FIG. 2, a floor covering 26 made in accordance with the present invention is shown installed on a vehicle compartment pan 28. The vehicle compartment pan 28 is part of a vehicle body (not shown). A decoupler 30 may be provided between the compartment pan 28 and the floor covering 26. The vehicle compartment pan 28 is contoured depending upon the vehicle design and may include a central tunnel area 32, a seating area 34, and a foot well area 36. The central tunnel 32 extends over the drive shaft of a rear wheel drive vehicle or over other components such as brake lines, fuel lines, and the like in front wheel drive vehicles. The seating area 34 is an area over which a plurality of vehicle seats may be attached. Foot well areas 36 flank either side of the central tunnel 32.

Referring to FIGS. 3 and 4, the floor covering 26 is provided with areas of normal thickness, e.g. 0.5 to 3 millimeters, represented by reference numeral 38, thicker portions, e.g. 0.75 to 5 millimeters, indicated by reference numeral 40, and thinner portions, 0.25 to 1.0 millimeters, indicated by reference numeral 42. The floor covering 26 is formed by the spraying process to have predetermined areas of thickness corresponding to the acoustical or vibration characteristics of the vehicle. The thickness is also controlled to provide thicker portions 40 in areas that require added durability such as the foot well area 36. The thinner portions 42 are preferably provided in areas such as the seating area 34 to reduce weight and minimize material costs.

The spray forming system 10 may be controlled so that the spray guns 18 and 20 deposit more of the polymer used to form the floor covering 26 in the thicker portions 40 while spraying at a reduced rate or with a reduced dwell time in the thinner portions 42.

Referring to FIG. 4, the thicker portion 40 is shown where the central tunnel 32 extends from the vehicle compartment pan 28. The thicker portion 40 could be provided over a sub-floor component that vibrates or otherwise requires acoustical deadening or vibration absorption. The thinner portion 42 could be provided in an area where a seat or central console is installed over the floor covering 26. In such areas, the seat or central console may provide vibration absorption or noise reduction and minimizes the need for additional thickness for durability because such areas are not subject to wear.

The spray forming system 10 may be used to efficiently and effectively control the thickness of the floor covering 26 made by the process. While certain areas were identified as being thicker portions 40 or thinner portions 42 in FIGS. 3 and 4, it should be understood that thickness variations may be provided in any desired location depending upon the noise control, vibration absorption, and durability requirement of the floor covering.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of making a vehicle floor covering comprising:
providing an open mold having a forming surface contoured to correspond to at least a portion of a vehicle compartment pan;
spraying a polyurethane mixture on the forming surface to form a polyurethane floor covering with a first thickness being applied on a first portion of the forming surface and a second thickness being applied on a second portion of the forming surface, wherein the first thickness is greater than the second thickness.

2. The method of claim 1 wherein the mixture sprayed in the spraying step is an aromatic polyurethane.

3. The method of claim 1 wherein the polyurethane is sprayed as a liquid that cures to a thermoset skin.

4. The method of claim 1 wherein the resultant polyurethane floor covering has a surface texture grain pattern that consistently matches the tool.

5. The method of claim 1 wherein the forming surface has a textured surface that is transferred to a top surface of the floor covering.

6. A vehicle floor covering made by a spray urethane process comprising a sprayed polyurethane skin molded to a contour corresponding to the shape of at least a portion of a vehicle compartment pan, the covering having a first thickness in certain portions and a second thickness greater than the first thickness in predetermined regions that are located to control noise and vibration to a greater extent than noise and vibration is controlled by the first thickness portions.

7. The vehicle floor covering of claim 6 wherein the vehicle compartment pan has seat receiving regions that are covered when a plurality of vehicle seats are assembled to the compartment pan.

8. The floor covering of claim 6 wherein the polyurethane covering is an aromatic polyurethane.

9. The floor covering of claim 6 wherein a top surface of the floor covering is a molded textured surface.

10. The floor covering of claim 6 wherein the first thickness is between 0.5 and 3 millimeters.

11. The floor covering of claim 6 wherein the second thickness thickness is greater than 0.75 millimeters.

12. A vehicle floor covering for a vehicle floor in a vehicle having acoustical hot spots that are focus points for the transmission of noise and vibration and baseline noise and vibration areas through which less noise and vibration is transmitted, the floor covering being formed with a plurality of different thicknesses that are varied to provide increased thickness over the hot spots and lesser thickness in baseline areas.

13. The vehicle floor covering of claim 12 wherein the thickness of the floor covering is increased in foot well areas.

14. The vehicle floor covering of claim 12 wherein the thickness of the floor covering is decreased in areas below seating areas.

15. The vehicle floor covering of claim 12 wherein the floor covering is placed on top of a decoupler that is installed on the floor of the vehicle.

16. The floor covering of claim 12 wherein the thickness of the floor covering in a baseline area is between 0.5 and 3 millimeters.

17. The floor covering of claim 12 wherein the thickness of the floor covering in an area of increased thickness is greater than 0.75 millimeters.
